(19) United States
(12) Patent Application Publication
(10) Pub. No.: US 2026/0116298 A1
(43) Pub. Date: Apr. 30, 2026

(54) VEHICLE INTERIOR MOUNT SYSTEM FOR ELECTRONIC DEVICE

(71) Applicant: Ford Global Technologies, LLC, Dearborn, MI (US)

(72) Inventor: Hector Eduardo Ramirez Lugo, San Mateo Atenco (MX)

(73) Assignee: Ford Global Technologies, LLC, Dearborn, MI (US)

(21) Appl. No.: 18/925,503

(22) Filed: Oct. 24, 2024

(51) Int. Cl. B60R 1/12

(52) U.S. Cl. CPC B60R 1/12; B60R 2001/1223

(57) ABSTRACT

A vehicle interior device mount system includes a bracket mount configured to extend from a vehicle component in a cabin interior of a vehicle. The bracket mount has opposing first and second sidewalls with a plurality of connecting features located on the first and second sidewalls. The system further includes an electronic device and a device holder having a frame configured to hold the electronic device. The frame has first and second levers on opposite sides. The first lever has a first retention feature configured to matingly engage a first connecting feature on the first sidewall, and the second lever has a second retention feature configured to matingly engage a second connecting feature on the second sidewall. The first and second levers may be actuated to disengage the retention features from the connecting features to remove the device holder and electronic device from the bracket mount.

### FIELD OF THE DISCLOSURE

The present disclosure generally relates to a vehicle mounted electronic device, and more particularly relates to a vehicle interior mount system for mounting an electronic device such as a camera.

### BACKGROUND OF THE DISCLOSURE

Motor vehicles are commonly equipped with electronic devices such as cameras for generating images. For example, one or more cameras may be mounted on a vehicle to acquire images of the roadway in front of the vehicle. Cameras may be mounted onto various structures such as an interior rearview mirror, for example. It may be desirable to provide for an enhanced mounting arrangement of an electronic device on the vehicle.

### SUMMARY OF THE DISCLOSURE

According to a first aspect of the present disclosure, a vehicle interior device mount system includes a bracket mount configured to extend from a vehicle component in a cabin interior of a vehicle. The bracket mount has opposing first and second sidewalls with a plurality of connecting features located on the first and second sidewalls. The device mount system further includes an electronic device and a device holder having a frame configured to hold the electronic device. The frame has first and second levers on opposite sides. The first lever has a first retention feature configured to matingly engage a first connecting feature on the first sidewall, and the second lever has a second retention feature configured to matingly engage a second connecting feature on the second sidewall. The first and second levers may be actuated to disengage the first and second retention features from the first and second connecting features to remove the device holder and the electronic device from the bracket mount.

Embodiments of the first aspect of the present disclosure can include any one or a combination of the following features:
the first and second connecting features comprise first and second openings in the first and second sidewalls of the bracket mount;
the retention features comprise first and second teeth;
the first and second levers each include a first portion folded back towards a second portion at an acute angle;
the frame further comprises a top retainer and a bottom retainer for retaining the electronic device;
the bracket mount further comprises alignment support features on the first and second walls for aligning and supporting the device holder in an opening;
the alignment support features comprise inward extending protrusions;
the electronic device comprises a camera;
the bracket mount includes a cavity configured to face a windshield on the vehicle and to accommodate the camera so as to capture images forward of the vehicle;
the camera comprises a driver assistance camera; and
the bracket mount is a mirror bracket mount on a rearview mirror assembly.

According to a second aspect of the present disclosure, a vehicle interior camera mount system includes a rearview mirror assembly having a mirror bracket mount configured to extend from a vehicle component in a cabin interior of a vehicle. The mirror bracket mount has opposing first and second sidewalls with a plurality of connecting features located on the first and second sidewalls. The camera mount system also includes a camera and a holder having a frame configured to hold the camera. The frame has first and second levers on opposite sides. The first lever has a first retention feature configured to matingly engage a first connecting feature on the first sidewall, and the second lever has a second retention feature configured to matingly engage a second connecting feature on the second sidewall. The first and second levers may be actuated to disengage the first and second retention features from the first and second connecting features to remove the holder and the camera from the mirror bracket mount.

Embodiments of the second aspect of the present disclosure can include any one or a combination of the following features:
the first and second connecting features comprise first and second openings in the first and second sidewalls of the mirror bracket mount;
the retention features comprise first and second teeth;
the first and second levers each include a first portion folded back towards a second portion at an acute angle;
the frame further comprises a top retainer and a bottom retainer for retaining the electronic device;
the mirror bracket mount further comprises alignment support features on the first and second walls for aligning and supporting the holder in an opening;
the alignment support features comprise inward extending protrusions;
mirror mount bracket includes a cavity configured to face a windshield on the vehicle and to accommodate the camera so as to capture images forward of the vehicle; and
the camera comprises a driver assistance camera.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a forward portion of a motor vehicle equipped with an electronic device in the form of a camera mounted on a mount system on a mirror mount of a rearview mirror assembly, according to one example;

FIG. 2 is a front perspective view of the rearview mirror assembly having the mount system provided thereon;

FIG. 3 is a front perspective view of the mount system with the electronic device and device holder assembled on the mount pedestal;

FIG. 3A is a top view of the mount system with the electronic device and the device holder assembled on the mount pedestal;

FIG. 4 is an exploded view of the mount system with the electronic device and device holder disassembled from the mount pedestal;

FIG. 4A is a top view of the mount system with the electronic device and device holder disassembled from the mount pedestal; and

FIG. 5 is a front perspective view of the mount system with the electronic device disassembled from the device holder.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

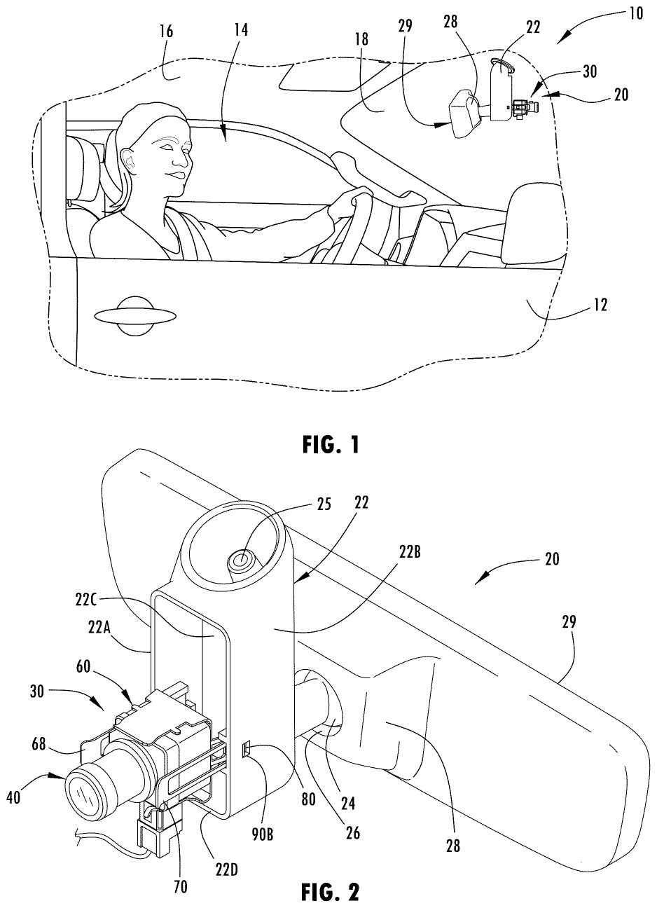

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle interior mount system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, an automotive or motor vehicle 10 is generally illustrated in the form of a passenger vehicle having a mount system 30 located on the motor vehicle 10 within the cabin interior 14 for mounting an electronic device, according to one embodiment. The motor vehicle 10 has a body 12 which generally defines the cabin interior 14. The body 12 typically has body panels, windows including a windshield 18, a roof 16 and access doors. The motor vehicle 10 is also equipped with a plurality of wheel and tire assemblies that couple to axles on the motor vehicle 10. The cabin interior 14 generally defines a passenger compartment that typically includes a plurality of seat assemblies. It should be appreciated that the motor vehicle 10 may be equipped with various seating arrangements and other various accommodations and accessories, in addition to the mounted electronic device such as an imaging camera that processes captured images and/or communicates signals via one or more antennas, according to various examples.

The vehicle body 12 further includes the roof 16 defining the top side of the cabin interior 14 and the windshield 18 generally at the front end of the cabin interior 14. The cabin interior 14 is equipped with a rearview mirror assembly 20 which in the exemplary embodiment shown is generally positioned below the roof 16 and rearward of the windshield 18. The rearview mirror assembly 20 may be connected to the roof 16 or a roof mounted headliner on the underside of the roof 16 or may be connected to the windshield 18. The rearview mirror assembly 20 includes a mirror mount 22 which includes a top end connection 25 for connecting to the roof 16 via fasteners on the top end, according to one example.

With reference to FIG. 2, the mirror mount 22 shown is a single pivot with a trilobe mount that generally has an elbow or L-shape body with a spherical ball joint mount 24 on a proximal lower end thereof (Single Pivot), according to one example. The ball joint mount 24 is configured to matingly engage with a ball socket 26 in a mirror housing 28 to allow the mirror housing 28 to rotate in a multitude of directions about the horizontal and vertical axes to adjust the mirror viewing alignment for the driver of the motor vehicle 10. The mirror housing 28 includes a mirror 29 on the rearward facing side which is generally used as a rearview mirror. In addition, the mirror housing 28 may house various electronics and other electrical circuitry components. Other types of mirror mounts such as wedge mounts and double pivot mounts may be used.

The rearview mirror assembly 20 includes a mount system 30 which is shown connected to the mirror mount 22. The mount system 30 includes a sliding and snap fit mount arrangement for receiving and connecting an electronic device 40 on the mirror bracket mount 22. The electronic device 40 may be a forward oriented imaging camera, such as a driver assistance camera, also referred to as an advanced driver assistance system (ADAS camera), according to one example. According to another example, the electronic device 40 may be an antenna. The electronic device 40 may be packaged in a housing, also referred to as a module. The electronic device 40 may be mounted onto the mirror bracket mount 22 within a central front cabin portion of the motor vehicle 10 generally rearward of the windshield 18.

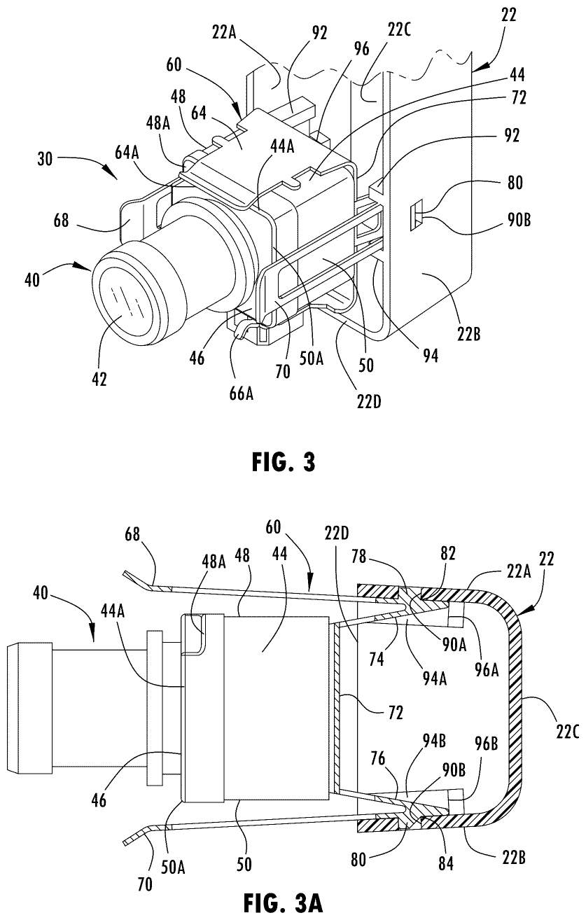

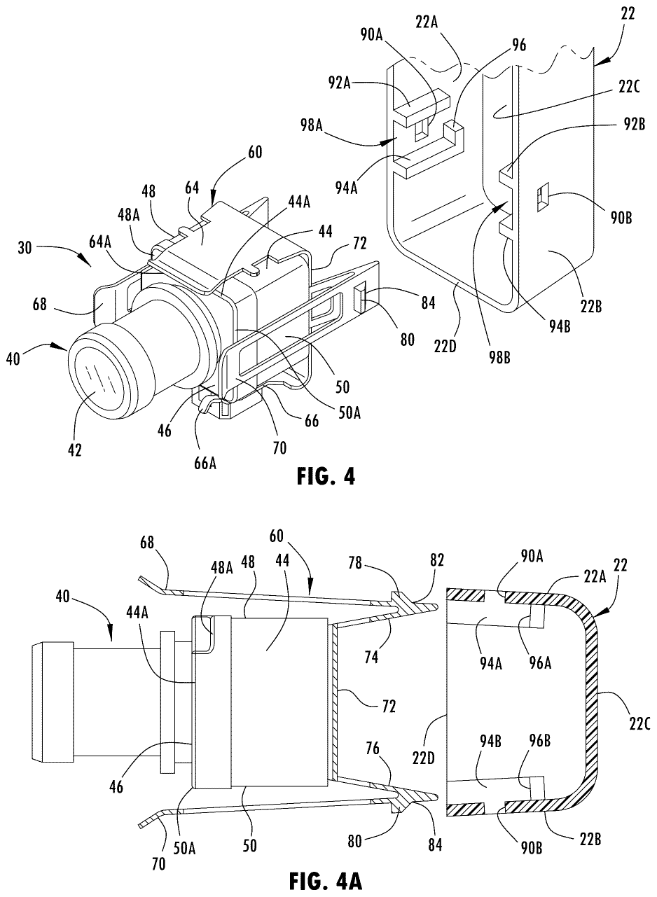

The mount system 30 includes the mirror bracket mount 22 which may be configured as a pedestal mount for supporting a rear view mirror housing. The mirror bracket mount 22 extends from a vehicle component such as the roof 16 or underlying headliner in the cabin interior 14 of the motor vehicle 10. The mirror bracket mount 22 has a body defining a housing with a generally hollow interior space that is configured to receive the electronic device 40 and a device holder 60 as shown in FIGS. 3-4A. The mirror bracket mount 22 has opposing sidewalls which generally include a left sidewall 22B and a right sidewall 22A as well as a rear wall 22C and an open front 22D generally defining a cavity for receiving the electronic device 40 assembled on the device holder 60. The cavity includes inward protruding projections 92A and 94A on the inside right sidewall 22A that defines corresponding right side slot 98A. The upper and lower projections 92A and 94A have parallel bars that create the slot 98A. The lower projection 94A includes an upright portion 96A on the rear end that acts as a stop member. The cavity includes inward protruding projections 92B and 94B on the inside left sidewall 22B that define the left side slot 98B. The upper and lower projections 92B and 94B likewise have parallel bars that create the slot 98B. The lower projection 94B includes an upright portion 96B on the rear end that acts as a stop member. Each of the right and left side walls further include a recess or an opening 90A or 90B which serve as first and second connecting features for matingly engaging the device holder 60 to hold the device holder 60 and electronic device 40 in place. The openings 90A and 90B are shown generally rectangular shaped, but may have other shapes and sizes.

The device holder 60 has first and second levers 68 and 70 on opposite sides. The first lever 68 has a first retention feature 78 in the form of a first outward protruding tooth configured to matingly engage the connecting feature in the form of opening 90A in the right sidewall 22A of the mirror bracket mount 22. The second lever 70 likewise has a second retention feature 80 in the form of a second outward protruding tooth configured to matingly engage the connecting feature of the opening 90B in the opposing left side wall 22B of the mirror bracket mount 22. The first lever 68 further includes a bent folded back portion 74 which is folded back at an acute angle, and the second lever 70 likewise includes a bent folded back portion 76 that is folded back at an acute angle. The first and second bent portions 74 and 76 are interconnected with a rear wall 72 that abuts the rear surface of the electronic device 40.

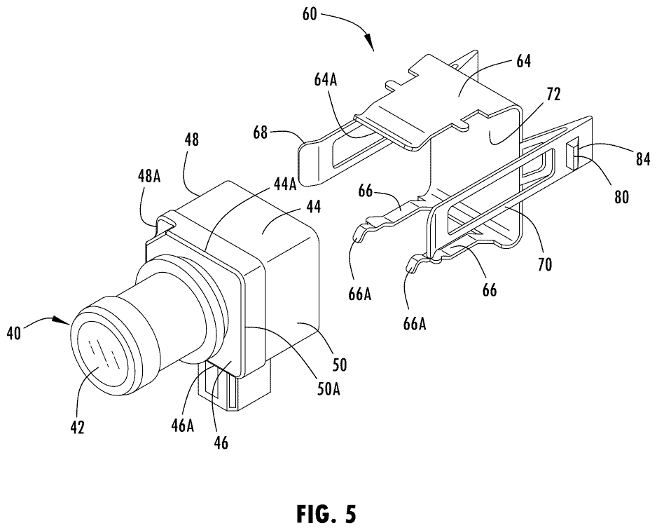

Referring to FIG. 5, the device holder 60 further includes a top wall 64 extending forward from the rear wall 72 and having a front retention surface 64A and a pair of spaced bottom fingers 66 each having bottom retention features 66A. The top wall 64 and bottom fingers 66 are spring loaded with a bias force and configured to engage the device housing under tension such that the retention fingers 64A and 66A retain the device holder 60 in place surrounding at least a portion of the electronic device 40.

The first and second levers 68 and 70 are configured to be received and slide within slots 98A and 98B on opposite opposing side walls of the mirror bracket mount 22 by sliding rearward between the upper and lower protrusions 92A and 92B and the upper and lower protrusions 94A and 94B. In doing so, a rear sloped portion 82 and 84 allows the first and second retention features 78 and 80 to slide into slots 98 and into placement and engagement within openings 90A and 90B, respectively, to hold the device holder 60 in place on the mirror bracket mount 22. With the first and second retention features 78 and 80 fully retained in openings 90A and 90B, the device holder 60 engaged with the electronic device 40 is supported on the mirror bracket mount 22.

It should be appreciated that the device holder 60 and the electronic device 40 may be easily removed from the mirror bracket mount 22, such as to allow for replacement or repair of the electronic device 40, for example. In order to remove the device holder 60 from the mirror bracket mount 22, a user may apply force to press levers 68 and 70 inward towards each other sufficient to cause the first and second retention features 78 and 80 to move inward and become disengaged from openings 90A and 90B, thereby allowing the device holder 60 to be pulled forward and removed. Once removed, the device holder 60 may be removed from the electronic device 40 by forcibly pulling the top wall 64 up via retention surface 64A and the bottom fingers 66 downward via bottom retention features 66A to enable to electronic device 40 to be separated therefrom.

Accordingly, the vehicle interior mount system 30 advantageously provides for a mounting arrangement in a motor vehicle 10 for an electronic device 40 such as a forward facing imaging camera that may be easily removed and reinstalled or replaced.

While the vehicle interior mount system 30 has been shown and described herein for mounting a camera device as the electronic device in a motor vehicle 10, it should be appreciated that other electronic devices such as an antenna, for example, may be mounted with the mount system 30. While the mount system 30 is shown and described herein mounted to the mirror mount 22 of a rearview mirror assembly 20, it should be appreciated that the mount system 30 may otherwise be provided on the mirror housing 28 itself or on another component within the cabin interior 14 of the motor vehicle 10 according to various other conceivable embodiments.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle interior device mount system comprising:
a bracket mount configured to extend from a vehicle component in a cabin interior of a vehicle, the bracket mount having opposing first and second sidewalls with a plurality of connecting features located on the first and second sidewalls;
an electronic device; and
a device holder having a frame configured to hold the electronic device, the frame having first and second levers on opposite sides, the first lever having a first retention feature configured to matingly engage a first connecting feature on the first sidewall and the second lever having a second retention feature configured to matingly engage a second connecting feature on the second sidewall, wherein the first and second levers may be actuated to disengage the first and second retention features from the first and second connecting features to remove the device holder and the electronic device from the bracket mount.

2. The vehicle interior device mount system of claim 1, wherein the first and second connecting features comprise first and second openings in the first and second sidewalls of the bracket mount.

3. The vehicle interior device mount system of claim 2, wherein the retention features comprise first and second teeth.

4. The vehicle interior device mount system of claim 3, wherein the first and second levers each include a first portion folded back towards a second portion at an acute angle.

5. The vehicle interior device mount system of claim 1, wherein the frame further comprises a top retainer and a bottom retainer for retaining the electronic device.

6. The vehicle interior device mount system of claim 1, wherein the bracket mount further comprises alignment support features on the first and second walls for aligning and supporting the device holder in an opening.

7. The vehicle interior device mount system of claim 6, wherein the alignment support features comprise inward extending protrusions.

8. The vehicle interior device mount system of claim 1, wherein the electronic device comprises a camera.

9. The vehicle interior device mount system of claim 8, wherein the bracket mount includes a cavity configured to face a windshield on the vehicle and to accommodate the camera so as to capture images forward of the vehicle.

10. The vehicle interior device mount system of claim 9, wherein the camera comprises a driver assistance camera.

11. The vehicle interior device mount system of claim 9, wherein the bracket mount is a mirror bracket mount on a rearview mirror assembly.

12. A vehicle interior camera mount system comprising:
a rearview mirror assembly having a mirror bracket mount configured to extend from a vehicle component in a cabin interior of a vehicle, the mirror bracket mount having opposing first and second sidewalls with a plurality of connecting features located on the first and second sidewalls;
a camera; and
a holder having a frame configured to hold the camera, the frame having first and second levers on opposite sides, the first lever having a first retention feature configured to matingly engage a first connecting feature on the first sidewall and the second lever having a second retention feature configured to matingly engage a second connecting feature on the second sidewall, wherein the first and second levers may be actuated to disengage the first and second retention features from the first and second connecting features to remove the holder and the camera from the mirror bracket mount.

13. The vehicle interior camera mount system of claim 12, wherein the first and second connecting features comprise first and second openings in the first and second sidewalls of the mirror bracket mount.

14. The vehicle interior camera mount system of claim 12, wherein the retention features comprise first and second teeth.

15. The vehicle interior camera mount system of claim 14, wherein the first and second levers each include a first portion folded back towards a second portion at an acute angle.

16. The vehicle interior camera mount system of claim 12, wherein the frame further comprises a top retainer and a bottom retainer for retaining the electronic device.

17. The vehicle interior camera mount system of claim 12, wherein the mirror bracket mount further comprises alignment support features on the first and second walls for aligning and supporting the holder in an opening.

18. The vehicle interior camera mount system of claim 17, wherein the alignment support features comprise inward extending protrusions.

19. The vehicle interior camera mount system of claim 12, wherein the mirror mount bracket includes a cavity configured to face a windshield on the vehicle and to accommodate the camera so as to capture images forward of the vehicle.

20. The vehicle interior camera mount system of claim 19, wherein the camera comprises a driver assistance camera.
